(19) United States
(12) Patent Application Publication
(10) Pub. No.: US 2013/0310511 A1
(43) Pub. Date: Nov. 21, 2013

(54) POLYMER MIXTURE

(71) Applicants: Prakash Druman Trivedi, Mumbai (IN); Jignesh Markandray Shukla, Gujarat (IN); Prakash Punjalal Panchal, Vadodara, Gujarat (IN); Sanjay Gurbasappa Charati, Gujarat (IN)

(72) Inventors: Prakash Druman Trivedi, Mumbai (IN); Jignesh Markandray Shukla, Gujarat (IN); Prakash Punjalal Panchal, Vadodara, Gujarat (IN); Sanjay Gurbasappa Charati, Gujarat (IN)

(73) Assignee: SOLVAY SA, Brussels (BE)

(21) Appl. No.: 13/995,737

(22) PCT Filed: Dec. 14, 2011
(86) PCT No.: PCT/EP2011/072783

§ 371 Date: Jun. 19, 2013

(30) Foreign Application Priority Data
Dec. 21, 2010 (IN) 3468/MUM/2010
Apr. 1, 2011 (EP) 11160875.8

(51) Int. Cl. C08K 3/36; B29C 45/00

(52) U.S. Cl. CPC C08K 3/36; B29C 45/0001
USPC 524/538; 524/606; 264/328.1

(57) ABSTRACT

A mixture comprising at least one polymer and from 0.1 wt % to 1.5 wt %, based on the weight of the polymer, of at least one fumed silica, wherein the polymer comprises at least one semi-aromatic polyamide in an amount of more than 50 wt %, based on the weight of the polymer. The presence of the fumed silica in the semi-aromatic polyamide-based mixture allows notably for reducing the cycle time necessary for the manufacture of various shaped articles, such as mobile phone housings, by melt processing methods like injection molding.

### CROSS REFERENCE TO RELATED APPLICATIONS

This application claims priority to Indian provisional patent application No. 3468/MUM/2010, filed on Dec. 21, 2010, and to European patent application No. 11160875.8, filed on Apr. 1, 2011, the whole content of each of these applications being incorporated herein by reference for all purposes.

### FIELD OF INVENTION

The invention relates to a mixture comprising at least one semi-aromatic polyamide and at least one additive.

The presence of the additive in the mixture of the present invention results in an effective early crystallization of the semi-aromatic polyamide at a higher temperature.

### BACKGROUND OF THE INVENTION

Various polyamide molding compositions and their process of preparation are well known in the art. For instance, U.S. Pat. No. 6,489,435 discloses a Polyamide produced by preparing an amidation-free slurry liquid comprising a diamine having at least 80 mol % xylylenediamine and a dicarboxylic acid in a batch-wise regulation tank, and feeding the slurry liquid to a batch-wise or continuous polymerization reactor as a starting material to produce the polyamide. The method produces polyamide having a desired balance of the diamine and dicarboxylic acid components without causing a problem, e.g. foaming or solidification.

U.S. Pat. No. 5,723,567 discloses copolyamides containing meta-xylylene diamine monomer units with reduced melt viscosity, stiffness and brittleness and unlike those prepared from caprolactam, the process disclosed do not require an additional extraction step during their preparation to remove excess residual lactam which can migrate. The copolyamides are reported to have improved barrier properties to gases.

U.S. Pat. No. 6,881,477B2 discloses polyamide molding composition prepared by (a) addition and dissolution of a solution of m-xylylenediamine and dicarboxylic acid with water and additives to a dissolver and preparation of a mixture; (b) polycondensation of the mixture in a reaction vessel; (c) granulation of the polycondensate; and (d) drying of the granulate. A nucleating agent in the form of pyrogenic silicic acid is used. The polyamide molding compositions is for production of packaging layers of improved carbon dioxide diffusion retarding properties compared with homopolyamide compositions.

A nylon packing film specially suited for food packaging industry is disclosed in CN1775858A which contains polyamide 60-94%, lubricant 2-20%, “anticonglutination” agent 1.5-10%, nucleating agent 1.5-10%, and coupling agent 0.1-1.0%. The process includes pre-processing of the anticonglutination agent and the nucleating agent with coupling agent; mixing polyamide, lubricant, anticonglutination agent and nucleating agent equally and extruding by twin-screw to form particle master batch under the temperature of 210-250 degree centigrade. The invention could decrease brittleness of film, improve diaphaneity and thermal contraction.

However, since the polyamides having low crystallization temperature suffer from warping when the polyamide article comes out from the mold, it has to be cooled sufficiently nearly to ambient temperature. This increases the cycle time, and makes it commercially not viable. The extent of crystallization at the temperature when the melt is cooled is also very poor.

The use of high glass transition temperature polyamides in high concentration is also known in polyamide compositions to enable crystallization at high temperature and reduced cycle time. However, when mixture of such polyamides is used in a composition, undesired trans-amidation is resulted.

Therefore, there is a need to develop a polyamide mold composition that would result in an effective early crystallization at a higher temperature when cooling from the melt, which will also reduce the cycle time on melt processing, in particular on injection molding.

### SUMMARY OF THE INVENTION

The invention provides a mixture comprising:
at least one polymer, and
at least one nucleating agent in an amount of from 0.1 wt % to 1.5 wt %, based on the weight of the polymer,

wherein the polymer comprises at least one semi-aromatic polyamide in an amount of more than 50 wt %, based on the weight of the polymer.

The nucleating agent is advantageously fumed silica.

In the invented mixture, the polymer may further comprise at least one aliphatic polyamide.

These and other features, aspects, and advantages of the present subject matter will become better understood with reference to the following description. This summary is provided to introduce a selection of concepts in a simplified form. This summary is not intended to identify key features or essential features of the subject matter, nor is it intended to be used to limit the scope of the subject matter of the invention.

### DETAILED DESCRIPTION

The invention provides a mixture comprising at least one polymer, and from 0.1 wt % to 1.5 wt %, based on the weight of the polymer, of at least one nucleating agent, wherein the polymer comprises more than 50 wt %, based on the weight of the polymer, of at least one semi-aromatic polyamide.

In particular, the present invention provides a mixture comprising at least one polymer, and from 0.2 wt % to 1.2 wt %, based on the weight of the polymer, of at least one nucleating agent, wherein the polymer comprises more than 50 wt %, based on the weight of the polymer, of at least one semi-aromatic polyamide.

The nucleating agent is advantageously fumed silica.

The fumed silica comprised in the mixture according to the present invention can be prepared by oxidizing organic and/or inorganic silicon compounds, such as silicon tetrachloride and/or silicon esters at temperature generally exceeding 1000 degree C. Then, it is commonly referred to as “pyrogenic silica”.

The fumed silica comprised in the mixture according to the present invention is generally in particulate form. The fumed silica particles may have a BET (N₂) specific surface area ranging from 50 to 450 m²/g; besides, they may have an average particle size of from 0.1 to 0.5 μm (in particular, from 0.2 μm to 0.3 μm), as determined by dynamic light scattering.

The fumed silica is notably commercially available as Aerosil®, Zeosil®, Cab-O-Sil®.

In a certain embodiment, the present invention provides a mixture comprising at least one polymer, and from 0.2 wt % to 1.5 wt %, preferably 0.2 wt % to 1.2 wt %, based on the weight of the polymer, of at least one fumed silica, wherein the polymer comprises at least one semi-aromatic polyamide in an amount of more than 50 wt %, based on the weight of the polymer.

In another embodiment of the present invention, the fumed silica is in the range of 0.3 wt % to 1.0 wt %, based on the weight of the polymer, wherein the polymer comprises of at least one semi-aromatic polyamide in more than 50 wt % based on the weight of the polymer.

In another embodiment of the present invention, the fumed silica is comprised in the mixture in an amount of about 0.8 wt %, based on the weight of the polymer, wherein the polymer comprises of at least one semi-aromatic polyamide in more than 50 wt % based on the weight of the polymer.

The addition of fumed silica in an amount according to the present invention, results in higher extent of crystallization as well as faster or early crystallization at higher temperature when cooling from melt. Hence the injection cycle time is reduced appreciably. The faster crystallization rate results advantageously into higher extrusion rate and/or lesser molding time.

The amount of fumed silica used in accordance with the present invention is an important technical feature for obtaining the desired results. If the amount is less than specified, it will render the crystallization temperature (Tc) of the mixture very low. Surprisingly, if the amount of fumed silica is higher than specified, it will also render the crystallization temperature (Tc) of the mixture very low. Without being bound by any theory, the Applicant believes that using a too high amount of fumed silica might result in formation of agglomerates inside the polymer matrix, which in turn might be detrimental to the obtention of a polyamide mixture exhibiting a high crystallization temperature.

In another embodiment, the mixture of the present invention comprises at least one semi-aromatic polyamide (PA).

In a particular embodiment, the semi-aromatic polyamide is present in an amount of more than 85 wt %, based on the weight of the polymer.

For the purpose of the present description, the term “semi-aromatic polyamide” is defined as any polymer which comprises more than 50 mole % of recurring units obtainable by (and preferably, obtained by) the polycondensation reaction between at least one non-aromatic (or aliphatic) diacid (or derivative thereof) and at least one aromatic diamine, and/or recurring units obtainable by (and preferably, obtained by) the polycondensation reaction between at least one aromatic diacid (or derivative thereof) and at least one non-aromatic (aliphatic) diamine.

A diacid (or derivative thereof) or a diamine or an amino-carboxylic acid (or derivative thereof) is considered for the purpose of this invention as “aromatic” when it comprises at least one aromatic group. A diacid (or derivative thereof) or a diamine or an amino-carboxylic acid (or derivative thereof) is considered for the purpose of this invention as “non-aromatic” when it is free from aromatic group.

A first class of semi-aromatic polyamides (PA) are semi-aromatic polyamides (PA1) comprising more than 50 mole % of recurring units obtainable by (and preferably, obtained by) the polycondensation reaction between at least one aliphatic diacid (or derivative thereof) and at least one aromatic diamine; preferably more than 75 mole %, and more preferably more than 85 mole %, of said recurring units can be obtained (and preferably, are obtained) by the polycondensation reaction between at least one aliphatic diacid or derivative thereof and at least one aromatic diamine. Still more preferably, essentially all or even all the recurring units of the semi-aromatic polyamides (PA1) can be obtained (and preferably, are obtained) by the polycondensation reaction between at least one aliphatic diacid (or derivative thereof) and at least one aromatic diamine.

The term diacid derivative is intended to encompass acid halogenides, especially chlorides, acid anhydrides, acid salts, acid amides and the like, which can be advantageously used in the polycondensation reaction.

The expression “at least one aliphatic diacid or derivative thereof” and “at least one aromatic diamine” are understood to mean that one or more than one aliphatic diacid or derivative thereof and one or more than one aromatic diamine can be made to react as above specified.

The expression “at least one aromatic diacid or derivative thereof” and “at least one aliphatic diamine” are understood to mean that one or more than one aromatic diacid or derivative thereof and one or more than one aliphatic diamine can be made to react as above specified.

Non limitative examples of aromatic diamines are notably m-phenylene diamine (MPD), p-phenylene diamine (PPD), 3,4′-diaminodiphenyl ether (3,4′-ODA), 4,4′-diaminodiphenyl ether (4,4′-ODA), m-xylylenediamine (MXDA), as shown below:

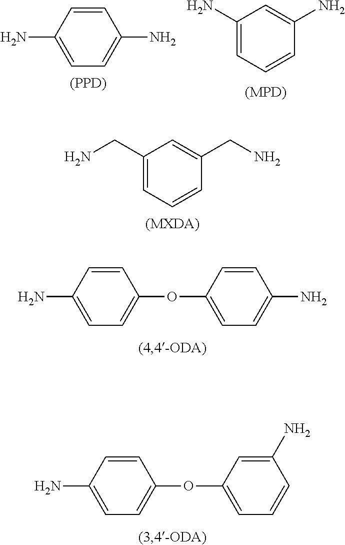

and p-xylylenediamine (PXDA, not represented).

The aromatic diamine is preferably m-xylylenediamine (MXDA).

Non limitative examples of aliphatic diacids are notably oxalic acid (HOOC—COOH), malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecanedioic acid [HOOC—(CH₂)₁₀—COOH], tetradecanedioic acid [HOOC—(CH₂)₁₁—COOH].

The aliphatic diacid is preferably adipic acid.

As above mentioned, such aliphatic diacids can be used in the polycondensation reaction notably under the form of free acid and acid chloride.

According to the present invention the semi-aromatic polyamide (PA1) can be MXD6 or MXD10.

For the purpose of the present invention, a MXD6 polymer is intended to denote a semi-aromatic polyamide essentially all, if not all, the recurring units of which are obtainable by (and preferably, obtained by) the polycondensation reaction of adipic acid with meta-xylylene diamine.

MXD6 polymer materials are notably commercially available as IXEF® polyamides from Solvay Advanced Polymers, L.L.C.

Further, according to the present invention, MXD10 denotes a semi-aromatic polyamide essentially all, if not all, the recurring units of which are obtainable by (and preferably, obtained by) the polycondensation reaction of sebacic acid with meta-xylylene diamine. The sebacic acid can be derived from castor oil.

The molecular weight of the MXD6 or MXD10 polymer is not particularly limited.

For example, the MXD6 has advantageously a number average molecular weight (Mn) of at least 2,500, more preferably of at least 5,000, more preferably of at least 10,000 and still more preferably of at least 13,000.

In addition, the MXD6 has advantageously a number average molecular weight (Mₙ) of at most 60,000, more preferably of at most 50,000 and still more preferably of at most 30,000.

Mₙ can be calculated according to the following formula:

Mₙ=2×10⁶/Σ(—COOH end groups)+(—NH2 end groups)

(—COOH end groups)=number of acid end groups in μequivalents/gram of product resin (titrated with a base)
(—NH2 end groups)=number of basic end groups in μequivalents/gram of product resin (titrated with an acid).

Another class of semi-aromatic polyamides (PA) are semi-aromatic polyamides (PA2) comprising more than 50 mole % of recurring units obtainable by (and preferably, obtained by) the polycondensation reaction between at least one aromatic diacid (or derivative thereof) and at least one aliphatic diamine.

Non limitative examples of aliphatic diamines are notably 1,2-diaminoethane, 1,2-diaminopropane, propylene-1,3-diamine, 1,3-diaminobutane, 1,4-diaminobutane, 1,5-diaminopentane, 1,6-hexanediamine or hexamethylenediamine (HMDA), 1,8-diaminooctane, 1,10-diaminodecane, 1,12-diaminododecane, 1-amino-3-N-methyl-N-(3-aminopropyl)-aminopropane.

Preferred aliphatic diamine is hexamethylenediamine (HMDA).

Aromatic diacids and derivatives thereof employed in the polycondensation reaction to yield the semi-aromatic polyamides (PA2) are not particularly restricted. Non limitative examples of aromatic diacids are notably phthalic acids, including isophthalic acid (IPA), terephthalic acid (TPA) and orthophthalic acid (OPA), naphthalenedicarboxylic acids, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene.

Preferably, the semi-aromatic polyamides (PA2) are polyphthalamides, i.e. aromatic polyamides of which more than 50 mole % of the recurring units are obtainable by (and preferably, obtained by) the polycondensation reaction between at least one phthalic acid, chosen among IPA, TPA, PA and derivatives thereof, and at least one aliphatic diamine.

For the avoidance of doubt, chemical structures of IPA, TPA, PA are depicted herein below:

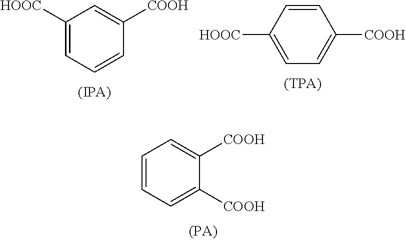 [SMILES: O=C(O)c1cccc(C(=O)O)c1 ; O=C(O)c1ccc(C(=O)O)cc1 ; O=C(O)c1ccccc1C(=O)O]

Suitable polyphthalamides are notably available as AMODEL® polyphthalamides from Solvay Advanced Polymers, L.L.C.

The semi-aromatic polyamides (PA2) of the present invention also covers poly(tere/iso)phthalamides.

For the purpose of the present invention, poly(tere/iso)phthalamides are defined as aromatic polyamides of which:
(i) more than 50 mole % of the recurring units are formed by the polycondensation reaction between terephthalic acid, isophthalic acid and at least one aliphatic diamine;
(ii) more than 25 and up to 50 mole % of the recurring units are formed by the polycondensation reaction between terephthalic acid and at least one aliphatic diamine; and
(iii) from 1 to 25 mole % of the recurring units are formed by the polycondensation reaction between isophthalic acid and at least one aliphatic diamine.

Poly(tere/iso)phthalamides may further comprise recurring units formed by the polycondensation reaction between at least one aliphatic diacid and at least one aliphatic diamine. In addition, poly(tere/iso)phthalamides are preferably free of recurring units formed by the polycondensation reaction between (ortho)phthalic acid (PA) and at least one diamine (aliphatic or aromatic).

Another embodiment of the invention provides a mixture wherein the semi-aromatic polyamide (PA2) is a polyterephthalamide.

For the purpose of the present invention, polyterephthalamides are defined as aromatic polyamides of which more than 50 mole % of the recurring units are formed by the polycondensation reaction between terephthalic acid and at least one aliphatic diamine.

A first class of polyterephthalamides consists of polyterephthalamides essentially all, if not all, the recurring units of which are formed by the polycondensation reaction between terephthalic acid and at least one aliphatic diamine [class (I)].

A second class of polyterephthalamides consists of polyterephthalamides essentially all, if not all, the recurring units of which are formed by the polycondensation reaction between terephthalic acid, isophthalic acid and at least one aliphatic diamine [class (II)].

A third class of polyterephthalamides consists of polyterephthalamides essentially all, if not all, the recurring units of which are formed by the polycondensation reaction between terephthalic acid, at least one aliphatic diacid and at least one aliphatic diamine [class (III)]. Such recurring units are respectively referred to as terephthalamide and aliphatic acid-amide recurring units.

Within class (III), a subclass consists of polyterephthalamides in which the mole ratio of the terephthalamide recurring units based on the total number of moles of the recurring units (i.e. the terephthalamide plus the aliphatic acid-amide recurring units) is 60 mole % or more; in addition, it is advantageously 80 mole % or less, and preferably 70 mole % or less [subclass (III-1)].

Within class (III), a second subclass consists of polyterephthalamides in which the mole ratio of the terephthalamide recurring units based on the total number of moles of the recurring units (i.e. the terephthalamide plus the aliphatic acid-amide recurring units) is less than 60 mole % [subclass (III-2)].

A fourth class of polyterephthalamides consists of polyterephthalamides essentially all, if not all, the recurring units of which are formed by the polycondensation reaction between terephthalic acid, isophthalic acid, at least one aliphatic diacid and at least one aliphatic diamine [class (IV)].

Aliphatic acids and aliphatic amines useful for classes (I) to (IV) are those above described as suitable for polymers (PA1) and (PA2).

Among all semi-aromatic polyamides (PA) described here above, semi-aromatic polyamides PA1 are often preferred as components of the polymer mixture in accordance with the invention. MXD6 polymers are especially preferred as the semi-aromatic polyamide (PA).

In certain embodiments in accordance with the present invention, the polymer is substantially free, essentially free or free of aliphatic polyamide. In said embodiments, the polymer may consist essentially of the semi-aromatic polyamide, or it may even consist of the semi-aromatic polyamide.

According to one further particular embodiment of the invention, at least one another polyamide (PA3) is incorporated into the polymer mixture in addition to the semi-aromatic polyamide (PA).

In one aspect of this particular embodiment, said polyamide (PA3), distinct from the semi-aromatic polyamide (PA), may be selected from the whole of the semi-aromatic polyamides (PA) described above themselves.

In another aspect of this particular embodiment, which is preferred, the at least one other polyamide (PA3) is selected among aliphatic polyamides.

In another aspect of the above embodiment, the amount of the aliphatic polyamide ranges from 2 to 20 wt % based on the weight of the semi-aromatic polyamide.

In a particular embodiment of the invention it provides a method for preparing the mixture of the present invention which comprises melt mixing the polymer with fumed silica.

In another embodiment, the process of melt mixing of the polymer with the fumed silica comprises melt extruding said polymer with said fumed silica.

In a particular embodiment of the invention it provides a method for manufacturing a shaped article, which comprises melt processing the mixture of the present invention. The melt processing according to the invention, comprises injection molding of the mixture of the present invention. The shaped article produced by such method can be an electronic component, preferably a mobile housing.

A particular embodiment of the present invention provides use of from 0.1 wt % to 1.5 wt % of at least one fumed silica as additive of at least one polymer comprising more than 50 wt % of at least one semi-aromatic polyamide, for reducing the cycle time of a method comprising melt processing the polymer for manufacturing a shaped article, wherein all the specified wt % are based on the weight of the polymer.

An embodiment of the invention also provides a shaped article prepared by molding, or by melt mixing or by melt processing the mixture of the present invention.

The shaped article can be an electronic component, preferably a mobile housing.

For the purpose of the present invention, the definition “aliphatic polyamide” is intended to denote any polyamide more than 50 mole %, preferably more than 75 mole % and more preferably more than 85 mole % of the recurring units of which are obtainable by (and preferably, obtained by) the polycondensation reaction between an aliphatic diacid (and/or a derivative thereof) and an aliphatic diamine, and/or by the auto-polycondensation reaction of an amino carboxylic acid and/or a lactam. Aliphatic diacids and aliphatic diamines are those above described as suitable for polymers (PA1) and (PA2).

Preferably, essentially all or even all the recurring units of the aliphatic polyamide (PA3) are obtainable by (and preferably, obtained by) the polycondensation reaction between at least one aliphatic diacid or derivative thereof and at least one aliphatic diamine.

More preferably, the aliphatic polyamide (PA3) is chosen from poly(hexamethylene adipamide) (nylon 66), poly(hexamethylene azelaamide) (nylon 69), poly(hexamethylene sebacamide) (nylon 610), poly(hexamethylene dodecanoamide) (nylon 612), poly(dodecamethylene dodecanoamide) (nylon 1212) and their copolymers. Examples of polyamides obtainable by (and preferably, obtained by) the auto-polycondensation reaction of an amino carboxylic acid and/or a lactam are the polycaprolactame (nylon 6), the polycaproamide and the poly (11-amino-undecano-amide).

More preferably, the aliphatic polyamide (PA3) is chosen from nylon 6 and nylon 66.

Still more preferably, the aliphatic polyamide (PA3) is nylon 66, i.e. the polyamide obtainable by (and preferably, obtained by) the polycondensation reaction between 1,6-hexamethylenediamine and adipic acid. In the mixture in accordance with the present invention, the polymer comprises the semi-aromatic polyamide in an amount of more than 50 wt %, preferably more than 70 wt. %, still more preferably more than 85 wt. %, based on the weight of the polymer.

In certain preferred embodiments, notably when the semi-aromatic polyamide is selected from the group consisting of semi-aromatic polyamides (PA1) comprising more than 50 mole % of recurring units obtainable by (and preferably, obtained by) the polycondensation reaction between at least one aliphatic diacid (or derivative thereof) and at least one aromatic diamine, such as MXD6 or MXD10, the polymer further the aliphatic polyamide (PA3). Then, the amount of the aliphatic polyamide (PA3), based on the weight of the semi-aromatic polyamide, is advantageously of at least 2 wt. %, preferably at least 5 wt. % and more preferably at least 8 wt. %, based on the weight of the semi-aromatic polyamide (PA); besides, it is advantageously of at most 45 wt. %, preferably at most 20 wt. %, more preferably at most 12 wt. %, based on the weight of the semi-aromatic polyamide (PA).

Should the disclosure of any patents, patent applications, and publications which are incorporated herein by reference conflict with the description of the present application to the extent that it may render a term unclear, the present description shall take precedence.

The following examples are provided to further illustrate the present invention and are not to be construed as limiting the invention in any manner.

### Example 1-8

A semi-aromatic polyamide obtained by the polycondensation of sebacic acid derived from renewable resource castor oil and meta-xylylene diamine (MXD10) and having a relative viscosity range 2.1 to 2.7 (measured in a 98% sulfuric acid at a temperature of 25° C.) was mixed with various amounts of a untreated fumed silica (B.E.T. Surface Area: 200 m²/g) having an average particle size 0.2-0.3 microns and commercially available from CABOT Corporation under the designation Cab-O-Sil®. The samples were produced by melt extrusion using a twin-screw extruder operated in recycle mode (i.e. the material was transferred into an injection nozzle after a given residence time) at a barrel temperature between 190° C. and 200° C. and a screw rotation speed of 110 rpm and a residence time of 90 second.

The amount of Cab-O-Sil® was 0.02, 0.3, 0.5, 0.8, 2.0 and 5.0% by weight, based on the combined weight of semi-aromatic polyamide and Cab-O-Sil®. The analysis of the crystallization behavior by differential scanning calorimetry (DSC) showed a pronounced increase in the crystallization peak and onset temperatures. First heating, cooling and second heating traces were recorded at a rate of 10° C./min; the instrument was purged using nitrogen gas. After first heating, the sample was kept in the melt at 250° C. for 10 minutes to erase its thermal history. An average of three samples was taken for data analysis. The neat MXD10 displayed very low crystallization rates with broad crystallization peaks in DSC cooling experiments centered around a peak value of about 125° C.

At a load of fumed silica of 0.8% by weight, based on the weight of polyamide and Cab-O-Sil®, the best result of crystallization peak of around 147° C. and extent of crystallization ΔH=47 J/g were observed.

The crystallization temperature and ΔH value profile of examples 1-8 are set forth in table 1.

Examples marked hereunder with a “C” superscript are presented for comparison purposes.

TABLE 1

| | | Tc on | ΔH |
|---|---|---|---|
| Example | Mixture | cooling (° C.) | (J/g) |
| 1^{C} | MXD10 (Extruded beads) | 111.8 | 09.3 |
| 2^{C} | MXD10 (Molded sample) | 125.6 | 35.5 |
| 3^{C} | MXD10 + 0.02 % fumed silica | 129.1 | 40.6 |
| 4 | MXD10 + 0.3 % fumed silica | 144.5 | 32.2 |
| 5 | MXD10 + 0.5 % fumed silica | 145.1 | 43.1 |
| 6 | MXD10 + 0.8 % fumed silica | 147.3 | 47.4 |
| 7^{C} | MXD10 + 2.0 % fumed silica | 131.3 | 43.3 |
| 8^{C} | MXD10 + 5.0 % fumed silica | 144.0 | 44.4 |

### Example 9-11

A semi-aromatic polyamide obtained by the polycondensation of adipic acid and meta xylylene diamine (MXD6) and having a relative viscosity of 2.1 (measured in 98% sulfuric acid at a temperature of 25° C.) was mixed with various amounts of untreated fumed silica (B.E.T. Surface Area: 200 m²/g) having an average particle size 0.2-0.3 microns and commercially available from CABOT Corporation under the designation Cab-O-Sil®. The samples were produced by melt extrusion using a twin-screw extruder operated in recycle mode (i.e. the material is transferred into an injection nozzle after a given residence time) at a barrel temperature between 240° C. and 250° C. and a screw rotation speed of 110 rpm and a residence time of 90 second. The amount of Cab-O-Sil® used were 0.02, 0.3, 0.5, 0.8, 2.0 and 5.0% by weight, based on the combined weight of semi-aromatic polyamide and Cab-O-Sil. The analysis of the crystallization behavior by differential scanning calorimetry (DSC) showed a pronounced increase in the crystallization peak and onset temperatures. First heating, cooling and second heating traces were recorded at a rate of 10° C./min; the instrument was purged using nitrogen gas. After first heating, the sample was kept in the melt at 280° C. for 10 minutes to erase its thermal history. An average of three samples was taken for data analysis. The unfilled neat MXD6 displayed very low crystallization rates with broad crystallization peaks in DSC cooling experiments centered around a peak value of about 125° C.

At a load of 0.8% by weight, based on the weight of polyamide and Cab-O-Sil®, best result of crystallization peak of around 191° C. and extent of crystallization ΔH=54 J/g were observed.

Examples marked here below with a “C” superscript are presented for comparison purposes.

TABLE 2

| | | Tc on | ΔH |
|---|---|---|---|
| Examples | Mixture | cooling (° C.) | (J/g) |
| 9^{C} | MXD6 (Molded sample) | 164.3 | 43.72 |
| 10 | MXD6 + 0.8 % fumed silica | 191.6 | 54.77 |
| 11^{C} | MXD6 + 5.0 % fumed silica | 187.3 | 52.11 |

The crystallization temperature, Tc on cooling was 164.3° C. for neat MXD6. For mixture containing 0.8% Cab-O-Sil (fumed silica), Tc was 191.6° C. and 187.28° C. with 5.0% Cab-O-Sil.

The faster crystallization rate as shown in table 1 and table 2 during cooling for the mixtures of the present invention indicates higher extrusion rate and lesser molding time.

### Example 12

### Injection Cycle Time Study

The equipment used was Injection Molding Machine LTM Demag D 60-NC4K. The molding parameters are given in Table 3.

TABLE 3
Molding process parameters

| Barrel temperature | 200-190° C. | |
|---|---|---|
| Injection Pressure | 750 | Bar |
| Injection Speed | 25 | cm³/sec |
| Holding Pressure | 600 | Bar |
| Holding Time | 4 | Sec |
| Screw speed | 60 | RPM |

The result of the study at mold temperatures 40 and 20° C. is summarized in table 4.

TABLE 4

| | Cycle time (in Seconds) | |
|---|---|---|
| | Mold Temperature | Mold Temperature |
| Mixture | @ 40° C. | @ 20° C. |
| MXD10 (for comparison) | 75 | 65 |
| MXD10 + 0.8% Cabosil M-5 | 69 | 55 |
| Reduction in time (Second) | 6 | 10 |
| Reduction in time (%) | 8 | 15 |

The mixture of the present invention showed lesser cycle time.

Although the subject matter has been described in considerable detail with reference to certain preferred embodiments thereof, other embodiments are possible. As such, the spirit and scope of the appended claims should not be limited to the description of the preferred embodiment contained therein.

1. A mixture comprising:
at least one polymer, and
from 0.1 wt % to 1.5 wt %, based on the weight of the polymer, of at least one fumed silica,
wherein the polymer comprises at least one semi-aromatic polyamide in an amount of more than 50 wt %, based on the weight of the polymer.

2. The mixture according to claim 1, which comprises from 0.2 wt % to 1.2 wt %, based on the weight of the polymer, of the fumed silica.

3. The mixture according to claim 2, which comprises from 0.3 wt % to 1.0 wt %, based on the weight of the polymer, of the fumed silica.

4. The mixture according to claim 1, wherein the polymer comprises at least one semi-aromatic polyamide in an amount of more than 85 wt %, based on the weight of the polymer.

5. The mixture according to claim 1, wherein the polymer further comprises at least one aliphatic polyamide.

6. The mixture according to claim 5, wherein the amount of the aliphatic polyamide, ranges from 2 to 20 wt. %, based on the weight of the semi-aromatic polyamide.

7. The mixture according to claim 1, wherein the polymer is essentially free of aliphatic polyamide.

8. The mixture according to claim 7, wherein the polymer consists essentially of the semi-aromatic polyamide.

9. The mixture according to claim 1, wherein said semi aromatic polyamide is polyamide MXD6 or polyamide MXD10.

10. A method for preparing the mixture according to claim 1, which comprises melt mixing said polymer with said fumed silica.

11. The method according to claim 10, wherein the melt mixing of said polymer with said fumed silica comprises melt extruding said polymer with said fumed silica.

12. A method for manufacturing a shaped article, which comprises melt processing the mixture according to claim 1.

13. The method according to claim 12, wherein the melt processing of said mixture comprises injection molding said mixture.

14. The method according to claim 12, wherein said shaped article is an electronic component.

15. (canceled)

16. A mixture comprising:
at least one polymer, and
from 0.2 wt % to 1.2 wt %, based on the weight of the polymer, of at least one fumed silica,
wherein the polymer comprises at least one semi-aromatic polyamide in an amount of more than 70 wt %, based on the weight of the polymer; and
wherein said semi-aromatic polyamide is selected from the group consisting of semi-aromatic polyamides (PA1) comprising more than 85 mole % of recurring units obtained by a polycondensation reaction between at least one aliphatic diacid and at least one aromatic diamine.

17. The mixture according to claim 16, wherein said semi aromatic polyamide is polyamide MXD6 or polyamide MXD10.

18. A method for manufacturing a shaped article, which comprises injection molding the mixture according to claim 16.

19. A mixture comprising:
at least one polymer, and
from 0.3 wt % to 1.0 wt %, based on the weight of the polymer, of at least one fumed silica,
wherein the polymer comprises at least one semi-aromatic polyamide in an amount of more than 70 wt %, based on the weight of the polymer; and
wherein said semi-aromatic polyamide is polyamide MXD6 or polyamide MXD10.

20. The mixture according to claim 19, wherein the polymer comprises said semi-aromatic polyamide in an amount of more than 85 wt. %, based on the weight of the polymer.

21. A method for manufacturing a mobile phone housing, which comprises injection molding the mixture according to claim 20.
